(19) United States
(12) Patent Application Publication
(10) Pub. No.: US 2026/0110200 A1
(43) Pub. Date: Apr. 23, 2026

(54) LATCH SYSTEM WITH DOUBLE PAWL CONFIGURATION

(71) Applicant: Inteva Products, LLC, Troy, MI (US)

(72) Inventor: Marc Wilson, Waterford, MI (US)

(21) Appl. No.: 19/365,438

(22) Filed: Oct. 22, 2025

Related U.S. Application Data
(60) Provisional application No. 63/710,432, filed on Oct. 22, 2024.

(51) Int. Cl. E05B 85/26; E05B 85/04

(52) U.S. Cl. CPC E05B 85/26; E05B 85/045

(57) ABSTRACT

Disclosed is a latching system for a vehicle latch, including: a forkbolt for retaining a striker in a first striker position and a second striker position, the forkbolt configured for movement about a forkbolt pivot between at least a primary position and secondary position, the primary position corresponding to the first striker position and the secondary position corresponding to the second striker position; a primary detent configured for movement about a primary detent pivot, the primary detent having an elongated opening for rotatably receiving the primary detent pivot, the elongated opening being larger than the primary detent pivot; and a secondary detent configured for movement about a secondary detent pivot, wherein the primary detent has a bite for contact with the secondary detent and a radius of the bite of the primary detent is centered with a center of the elongated opening such that as the forkbolt moves from the second striker position to the first striker position the primary detent translates or moves with respect to the primary detent pivot and the primary detent also rotates about the primary detent pivot.

### CROSS REFERENCE TO RELATED APPLICATIONS

The present application claims the benefit of U.S. Provisional Patent Application Ser. No. 63/710,432 filed on Oct. 22, 2024, the entire contents of which are incorporated herein by reference thereto.

### BACKGROUND

Exemplary embodiments of the present disclosure pertain to the art of vehicle latches.

Conventional latch systems use a forkbolt or claw rotating about a fixed pivot and detent or pawl rotating about a fixed pivot to retain a moveable striker. The vast majority of latch systems retain the striker in two discreet positions with some amount of linear separation. In the instance of a large applied force to the striker with the conventional latch system, it may not be possible to rotate the detent or pawl out of engagement from the forkbolt or claw, preventing the latch from releasing the striker.

An alternative latch system design consists of a forkbolt or claw rotating about a fixed pivot, a primary detent or pawl rotating about a fixed pivot, and a secondary detent or pawl rotating about a fixed pivot. In this alternative design, the primary detent or pawl is biased such that it will tend to auto-disengage from the forkbolt or claw once the secondary detent or pawl is moved out of engagement from the primary detent or pawl. The alternative design requires significantly less energy to release a high load applied to the striker. However, the heretofore described alternative design is not typically able to move from the second striker position to first striker position during the latch closing operation.

One solution for this problem is a latch system that only uses the primary detent or pawl-secondary detent or pawl system to retain the forkbolt or claw in the first striker position. A separate detent or pawl lever is then used to retain the forkbolt or claw in the second striker position. This solution is not optimal as it requires additional components and manufacturing steps.

### BRIEF DESCRIPTION

Disclosed is a latching system for a vehicle latch, including: a forkbolt for retaining a striker in a first striker position and a second striker position, the forkbolt configured for movement about a forkbolt pivot between at least a primary position and secondary position, the primary position corresponding to the first striker position and the secondary position corresponding to the second striker position; a primary detent configured for movement about a primary detent pivot, the primary detent having an elongated opening for rotatably receiving the primary detent pivot, the elongated opening being larger than the primary detent pivot; and a secondary detent configured for movement about a secondary detent pivot, wherein the primary detent has a bite for contact with the secondary detent and a radius of the bite of the primary detent is centered with a center of the elongated opening such that as the forkbolt moves from the second striker position to the first striker position the primary detent translates or moves with respect to the primary detent pivot and the primary detent also rotates about the primary detent pivot.

In addition to one or more of the features described above, or as an alternative to any of the foregoing embodiments, the primary detent is configured for movement between an engaged position and disengaged position and the secondary detent is configured for movement between an engaged position and disengaged position, wherein when the primary detent is in the engaged position and the secondary detent is in the engaged position, the forkbolt is prevented from moving from the primary position.

In addition to one or more of the features described above, or as an alternative to any of the foregoing embodiments, further including a primary detent spring for biasing the primary detent into the engaged position; and a secondary detent spring for biasing the secondary detent into the engaged position.

In addition to one or more of the features described above, or as an alternative to any of the foregoing embodiments, further including: a backing plate, the forkbolt pivot, the primary detent pivot and the secondary detent pivot each being fixedly secured to the backing plate.

In addition to one or more of the features described above, or as an alternative to any of the foregoing embodiments, when the primary detent is in the disengaged position, the primary detent does not prevent movement of the forkbolt from the primary position.

In addition to one or more of the features described above, or as an alternative to any of the foregoing embodiments, when the secondary detent is in the engaged position it will contact the primary detent and prevent the primary detent from moving from engaged position towards the disengaged position.

In addition to one or more of the features described above, or as an alternative to any of the foregoing embodiments, when the primary detent is in the disengaged position, the primary detent does not prevent movement of the forkbolt from the primary position.

In addition to one or more of the features described above, or as an alternative to any of the foregoing embodiments, when the secondary detent is in the engaged position it will contact the primary detent and prevent the primary detent from moving from engaged position towards the disengaged position.

In addition to one or more of the features described above, or as an alternative to any of the foregoing embodiments, when the secondary detent is in the engaged position it will contact the primary detent and prevent the primary detent from moving from engaged position towards the disengaged position.

Also disclosed is a vehicle latch, including: a latching system for a vehicle latch, including: a forkbolt for retaining a striker in a first striker position and a second striker position, the forkbolt configured for movement about a forkbolt pivot between at least a primary position and secondary position, the primary position corresponding to the first striker position and the secondary position corresponding to the second striker position; a primary detent configured for movement about a primary detent pivot, the primary detent having an elongated opening for rotatably receiving the primary detent pivot, the elongated opening being larger than the primary detent pivot; and a secondary detent configured for movement about a secondary detent pivot, wherein the primary detent has a bite for contact with the secondary detent and a radius of the bite of the primary detent is centered with a center of the elongated opening such that as the forkbolt moves from the second striker position to the first striker position the primary detent translates or moves with respect to the primary detent pivot and the primary detent also rotates about the primary detent pivot.

In addition to one or more of the features described above, or as an alternative to any of the foregoing embodiments, the primary detent is configured for movement between an engaged position and disengaged position and the secondary detent is configured for movement between an engaged position and disengaged position, wherein when the primary detent is in the engaged position and the secondary detent is in the engaged position, the forkbolt is prevented from moving from the primary position.

In addition to one or more of the features described above, or as an alternative to any of the foregoing embodiments, further including: a primary detent spring for biasing the primary detent into the engaged position; and a secondary detent spring for biasing the secondary detent into the engaged position.

In addition to one or more of the features described above, or as an alternative to any of the foregoing embodiments, further including: a backing plate, the forkbolt pivot, the primary detent pivot and the secondary detent pivot each being fixedly secured to the backing plate.

In addition to one or more of the features described above, or as an alternative to any of the foregoing embodiments, when the primary detent is in the disengaged position, the primary detent does not prevent movement of the forkbolt from the primary position.

In addition to one or more of the features described above, or as an alternative to any of the foregoing embodiments, when the secondary detent is in the engaged position it will contact the primary detent and prevent the primary detent from moving from engaged position towards the disengaged position.

In addition to one or more of the features described above, or as an alternative to any of the foregoing embodiments, when the primary detent is in the disengaged position, the primary detent does not prevent movement of the forkbolt from the primary position.

In addition to one or more of the features described above, or as an alternative to any of the foregoing embodiments, when the secondary detent is in the engaged position it will contact the primary detent and prevent the primary detent from moving from engaged position towards the disengaged position.

In addition to one or more of the features described above, or as an alternative to any of the foregoing embodiments, when the secondary detent is in the engaged position it will contact the primary detent and prevent the primary detent from moving from engaged position towards the disengaged position.

Also disclosed is a method for retaining and releasing a striker of a latching system for a vehicle latch, including: retaining a striker in a first striker position and a second striker position with a forkbolt, the forkbolt configured for movement about a forkbolt pivot between at least a primary position and secondary position, the primary position corresponding to the first striker position and the secondary position corresponding to the second striker position; retaining the forkbolt in the primary position with a primary detent configured for movement about a primary detent pivot, the primary detent having an elongated opening for rotatably receiving the primary detent pivot, the elongated opening being larger than the primary detent pivot, the primary detent retaining the forkbolt in the primary position when the primary detent is in an engaged position; and retaining the primary detent in the engaged position with a secondary detent configured for movement about a secondary detent pivot, wherein the primary detent has a bite for contact with the secondary detent and a radius of the bite of the primary detent is centered with a center of the elongated opening such that as the forkbolt moves from the second striker position to the first striker position the primary detent translates or moves with respect to the primary detent pivot and the primary detent also rotates about the primary detent pivot, wherein the primary detent is configured for movement between the engaged position and disengaged position and the secondary detent is configured for movement between an engaged position and disengaged position, wherein when the primary detent is in the engaged position and the secondary detent is in the engaged position, the forkbolt is prevented from moving from the primary position.

In addition to one or more of the features described above, or as an alternative to any of the foregoing embodiments, further including biasing the primary detent into the engaged position with a primary detent spring; and biasing the secondary detent into the engaged position with a secondary detent spring.

### BRIEF DESCRIPTION OF THE DRAWINGS

The following descriptions should not be considered limiting in any way. With reference to the accompanying drawings, like elements are numbered alike:

FIG. 1 is a view of a latching system with a double pawl in a primary or fully latched position;

FIG. 2 is a view of the latching system in FIG. 1 in a secondary or partially latched position;

FIG. 3 is a view of the latching system in FIG. 1 moving from the secondary or partially latched position towards the primary or fully latched position;

FIG. 4 is a view of a latching system with a double pawl in a primary or fully latched position;

FIG. 5 is a view of the latching system in FIG. 1 moving towards an open position;

FIG. 6 is a view of a latching system with a double pawl in a primary or fully latched position;

FIG. 6A is an enlarged view of a portion of FIG. 6;

FIG. 7 is a view of the latching system in FIG. 6 in a secondary or partially latched position;

FIG. 8 is a view of the latching system in FIG. 6 moving from the secondary or partially latched position towards the primary or fully latched position;

FIG. 8A is an enlarged view of a portion of FIG. 8;

FIG. 9 is a view of a latching system with a double pawl in a primary or fully latched position;

FIG. 10 is a view of the latching system of FIG. 6 in an open position; and

FIG. 11 is a perspective view of a vehicle latch with the latching system of various embodiments of the present disclosure.

### DETAILED DESCRIPTION

A detailed description of one or more embodiments of the disclosed apparatus and method are presented herein by way of exemplification and not limitation with reference to the Figures.

The present disclosure is directed to a latching system 100 comprising a forkbolt or claw rotating about a fixed pivot, a primary detent or pawl that is able to rotate about either a fixed pivot or the contact point between the primary and secondary detents or pawls, and a secondary detent or pawl that is able to rotate about a fixed pivot. The present disclosure provides the benefits of the alternative latch system described above, but is able to move from the second striker position to the first striker position without the addition of more components.

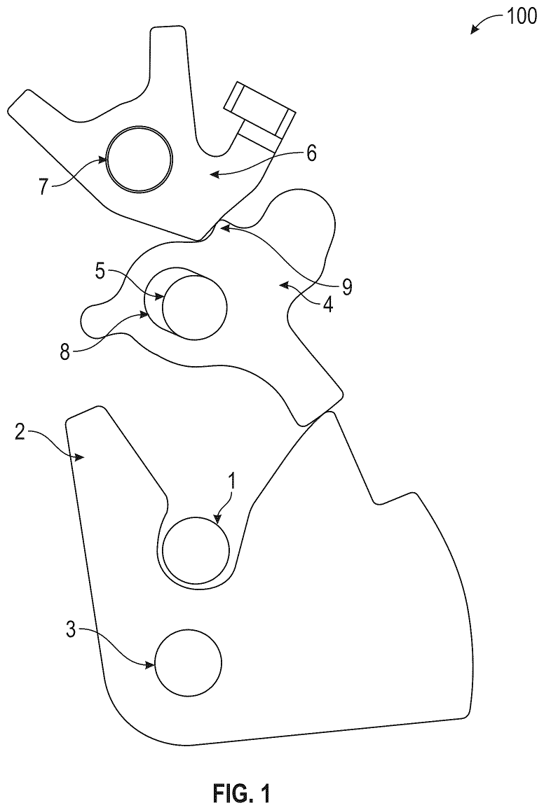

FIG. 1 shows the latching system 100 in a first striker position. Here a striker 1 is retained in the first striker position by the forkbolt or claw 2 which is prevented from rotating about its fixed pivot or forkbolt or claw pivot 3 by a primary detent or pawl 4. The primary detent or pawl 4 is prevented from rotating around its fixed pivot or primary detent or pawl pivot 5 and out of engagement from the forkbolt or claw by a secondary detent or pawl 6 which rotates about a fixed pivot or a secondary detent or pawl pivot 7. The primary detent or pawl 4 is constrained to its fixed pivot 5 with an arc-shaped slot or elongated opening 8 with the center of said arc or elongated opening being coincident with the center of the primary detent's or pawl's 4 primary detent-secondary detent bite radius 9. In the first striker position the striker 1 is in a first striker position which corresponds to the primary or latched position of the forkbolt or claw 2. In the first striker position, the primary detent or pawl 4 is in an engaged position such that is makes contact with the forkbolt or claw 2 to prevent its rotation counterclockwise with respect to the view illustrated in at least FIG. 1.

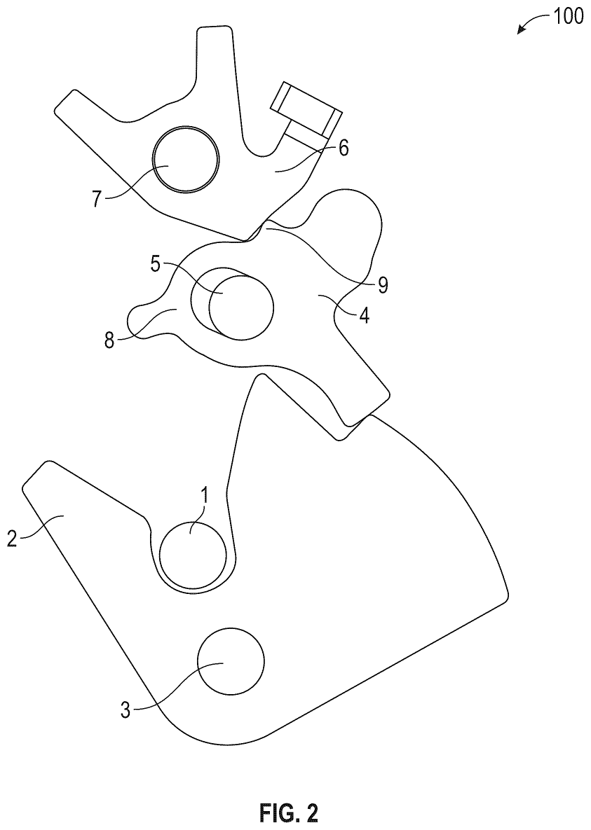

FIG. 2 shows the latching system in a second striker position. In the second striker position the striker 1 is in a second striker position which corresponds to a secondary or partially latched position of the forkbolt or claw 2. In the second striker position, the primary detent or pawl 4 is still in an engaged position such that is makes contact with the forkbolt or claw 2 to prevent its rotation counterclockwise with respect to the view illustrated in at least FIG. 2.

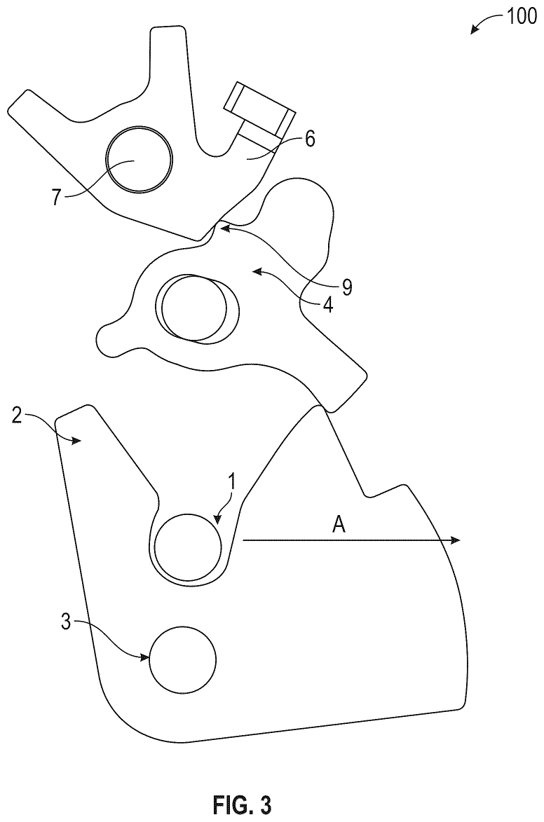

FIG. 3 shows the latching system during the striker 1 travel from the second striker position (FIG. 2) to the first striker position (FIG. 1), which also causes a corresponding movement of the forkbolt or claw 2 from the secondary or partially latched position to the first or primary latched position. This may be due to a closing or cinching force applied to the latching system 100. Movement of the striker 1 as indicated by arrow A causes the forkbolt or claw 2 to rotate about its fixed pivot 3. The forkbolt or claw makes contact with the primary detent or pawl 4 causing the primary detent or pawl to rotate about the primary detent's primary detent-secondary detent bite radius 9, which also causes the fixed pivot 5 to move within arc-shaped slot or elongated opening 8. This allows the forkbolt or claw 2 to move from the secondary or partially latched position to the primary or first latched position. In other words, this movement of the primary detent or pawl 4 including the movement of the fixed pivot 5 to move within arc-shaped slot or elongated opening 8 does not prevent the forkbolt or claw 2 from moving from the secondary or partially latched position to the primary or first latched position.

At a certain point of striker travel the primary detent or pawl 4 and secondary detent or pawl 6 will return to the positions shown in FIG. 1.

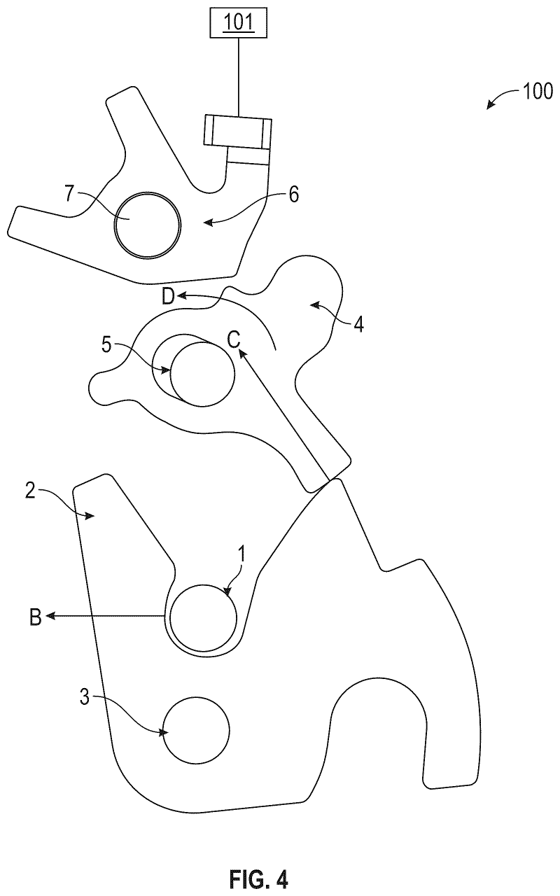

FIG. 4 shows the latching system 100 with the secondary detent or pawl 6 rotated out of engagement from the primary detent or pawl 4. This may be achieved by an actuator or handle 101 operatively coupled to the secondary detent or pawl 6. Force from the striker 1 as indicated by arrow B causes the forkbolt or claw 2 to rotate about its fixed pivot 3 and contact the primary detent or pawl. The contact force vector for this interaction, as indicated by arrow C, generates a moment on the primary pawl about its fixed pivot 5 as indicated by arrow D. Given sufficient striker force in the direction of arrow B, the primary detent or pawl 4 will rotate out of engagement from the forkbolt or claw 2.

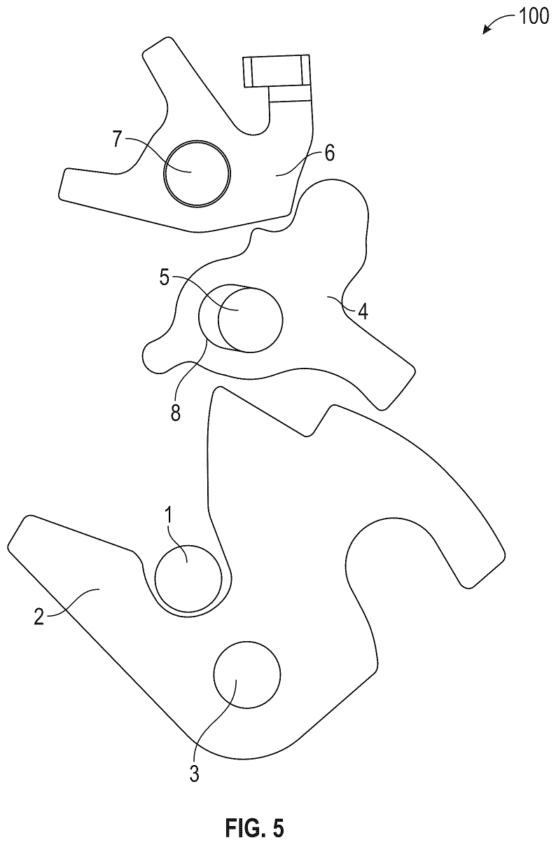

FIG. 5 shows the latching system 100 in a released position.

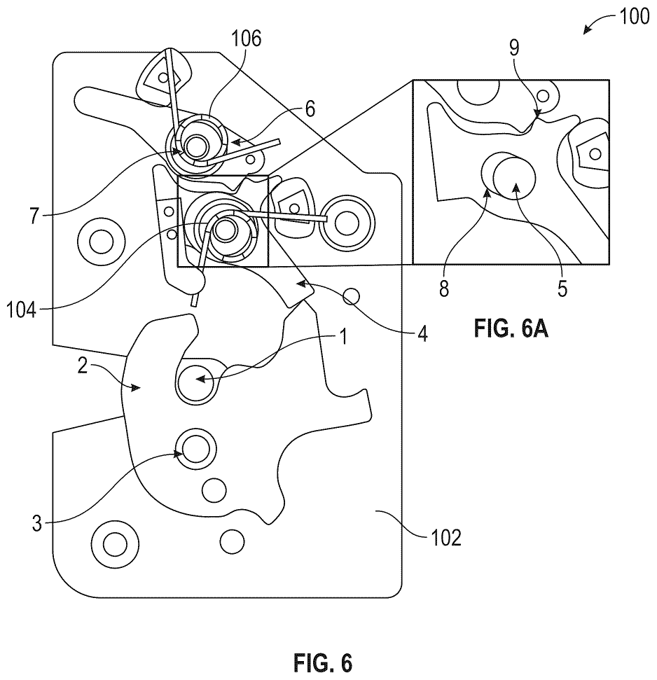

Referring now to FIGS. 6-10 the latching system 100 in accordance with various embodiments of the present disclosure is illustrated. Here the latching system 100 is shown with a frame or backing plate 102 to which, the forkbolt or claw 2, the primary detent or pawl 4 and the secondary detent or pawl 6 are pivotally or rotationally secured to. In FIGS. 6-10, the forkbolt or claw 2, the primary detent or pawl 4 and the secondary detent or pawl 6 have a slightly different configuration than those illustrated in FIGS. 1-5. Also, shown are a primary detent or pawl spring 104 and a secondary detent or pawl spring 106. The primary detent or pawl spring 104 biases the primary detent or pawl spring 104 into an engaged position with respect to the forkbolt or claw 2 and the secondary detent or pawl spring 106 biases the secondary detent or pawl 6 into an engaged position with respect to the primary detent or pawl 4. The forkbolt or claw 2 may be biased into the open position by a spring not shown and the forkbolt or claw 2 is also rotated into the open position by movement of the striker 1 in the direction of arrow B, which may be attributable to the compressed seal about a door to which the latching system is secured to as is known in the related arts.

FIGS. 6 and 6A show the latching system 100 in a first striker position. FIG. 6A is an enlarged view of a portion of FIG. 6. Here a striker 1 is retained in the first striker position by the forkbolt or claw 2 which is prevented from rotating about its fixed pivot or forkbolt or claw pivot 3 by the primary detent or pawl 4. The primary detent or pawl 4 is prevented from rotating around its fixed pivot or primary detent or pawl pivot 5 and out of engagement from the forkbolt or claw 2 by a secondary detent or pawl 6 which rotates about a fixed pivot or secondary detent or pawl pivot 7. The primary detent or pawl 4 is constrained to its fixed pivot 5 with an arc-shaped slot or elongated opening 8 with the center of said arc or elongated opening being coincident with the center of the primary detent's or pawl's 4 primary detent-secondary detent bite radius 9. In the first striker position the striker 1 is in a first striker position which corresponds to the primary or latched position of the forkbolt or claw 2. In the first striker position, the primary detent or pawl 4 is in an engaged position such that is makes contact with the forkbolt or claw 2 to prevent its rotation counterclockwise with respect to the view illustrated in at least FIG. 6.

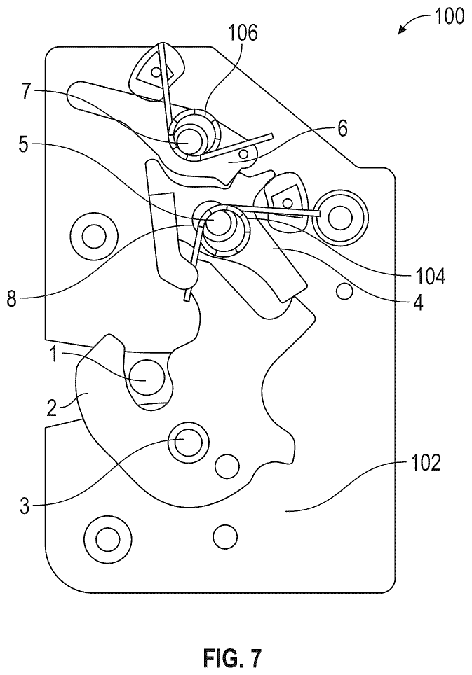

FIG. 7 shows the latching system in a second striker position. In the second striker position the striker 1 is in a second striker position which corresponds to a secondary or partially latched position of the forkbolt or claw 2. In the second striker position, the primary detent or pawl 4 is still in an engaged position such that is makes contact with the forkbolt or claw 2 to prevent its rotation counterclockwise with respect to the view illustrated in at least FIG. 2.

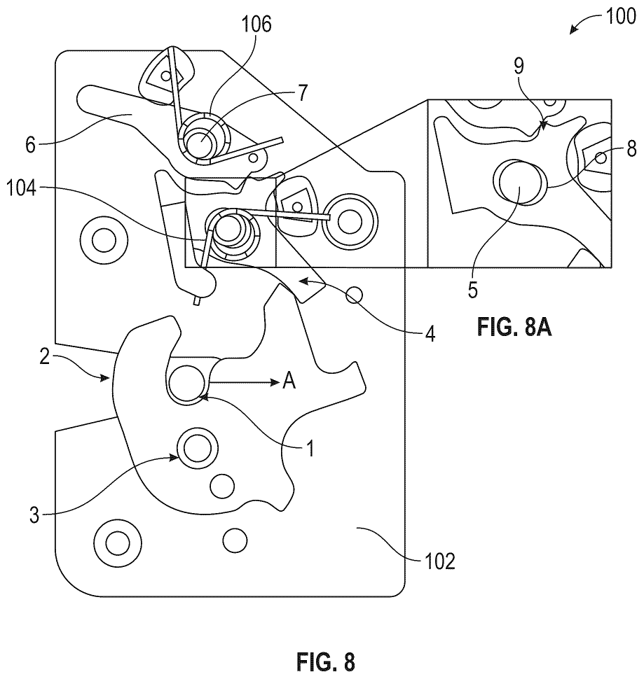

FIGS. 8 and 8A show the latching system 100 during the striker 1 travel from the second striker position (FIG. 7) to the first striker position (FIG. 6), which also causes a corresponding movement of the forkbolt or claw 2 from the secondary or partially latched position to the first or primary latched position. This may be due to a closing or cinching force applied to the latching system 100. Movement of the striker 1 as indicated by arrow A causes the forkbolt or claw 2 to rotate about its fixed pivot 3. The forkbolt or claw 2 makes contact with the primary detent or pawl 4 causing the primary detent or pawl to rotate about the primary detent's primary detent-secondary detent bite radius 9, which also causes the fixed pivot 5 to move within arc-shaped slot or elongated opening 8. This allows the forkbolt or claw 2 to move from the secondary or partially latched position to the primary or first latched position. In other words, this movement of the primary detent or pawl 4 including the movement of the fixed pivot 5 to move within arc-shaped slot or elongated opening 8 does not prevent the forkbolt or claw 2 from moving from the secondary or partially latched position to the primary or first latched position.

At a certain point of striker travel the primary detent or pawl 4 and secondary detent or pawl 6 will return to the positions shown in FIGS. 6 and 6A.

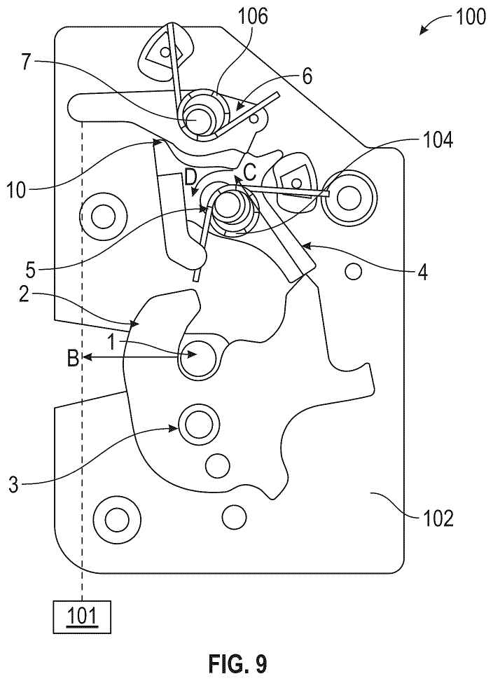

FIG. 9 shows the latching system 100 with the secondary detent or pawl 6 rotated out of engagement from the primary detent or pawl 4. This may be achieved by an actuator or handle 101 operatively coupled to the secondary detent or pawl 6 illustrated by the dashed lines in FIG. 9. Force from the striker 1 as indicated by arrow B causes the forkbolt or claw 2 to rotate about its fixed pivot 3 and contact the primary detent or pawl. The contact force vector for this interaction, as indicated by arrow C, generates a moment on the primary pawl about its fixed pivot 5 as indicated by arrow D. Given sufficient striker force in the direction of arrow B, the primary detent or pawl 4 will rotate out of engagement from the forkbolt or claw 2. Additional counterclockwise rotation (with respect to the view illustrated in at least FIG. 9) of the secondary detent or pawl 6 will cause contact of the secondary detent or pawl 6 with the primary detent at point 10, which will rotate the primary detent or pawl 6 counterclockwise (with respect to the view illustrated in at least FIG. 9) to ensure the primary detent or pawl 6 rotates clear from forkbolt or claw 2.

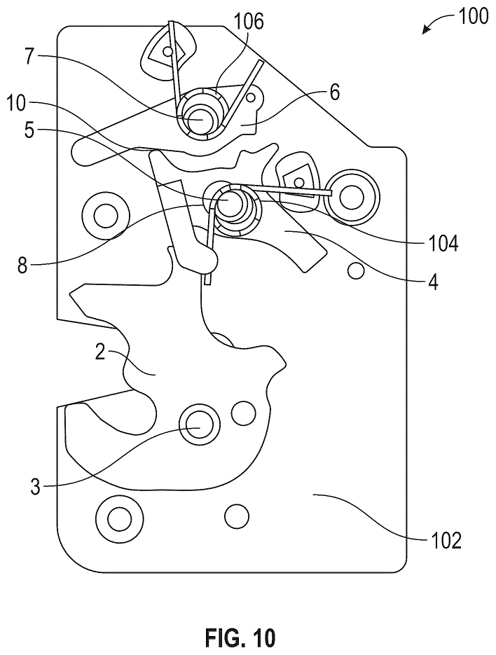

FIG. 10 shows the latching system 100 in a released position.

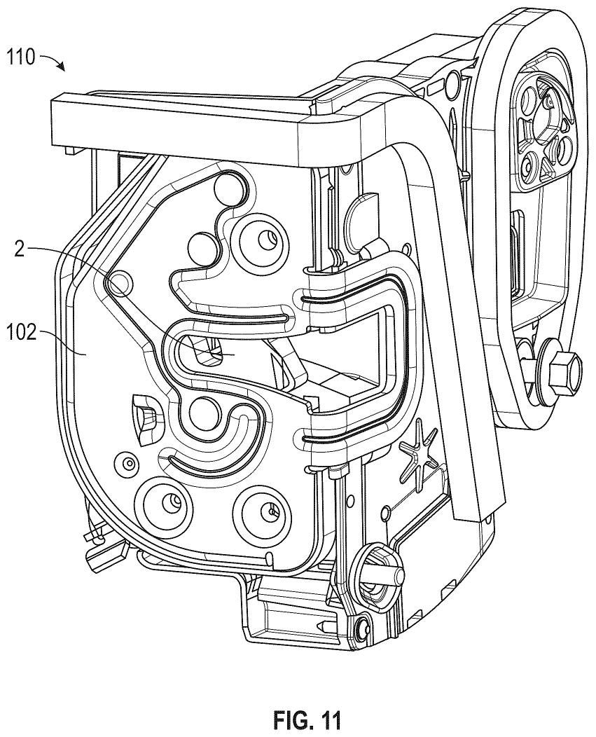

FIG. 11 shows one non-limiting configuration of a vehicle latch 110 with the latching system 100 of various embodiments of the present disclosure.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A latching system for a vehicle latch, comprising:
a forkbolt for retaining a striker in a first striker position and a second striker position, the forkbolt configured for movement about a forkbolt pivot between at least a primary position and secondary position, the primary position corresponding to the first striker position and the secondary position corresponding to the second striker position;
a primary detent configured for movement about a primary detent pivot, the primary detent having an elongated opening for rotatably receiving the primary detent pivot, the elongated opening being larger than the primary detent pivot; and
a secondary detent configured for movement about a secondary detent pivot, wherein the primary detent has a bite for contact with the secondary detent and a radius of the bite of the primary detent is centered with a center of the elongated opening such that as the forkbolt moves from the second striker position to the first striker position the primary detent translates or moves with respect to the primary detent pivot and the primary detent also rotates about the primary detent pivot.

2. The latching system as in claim 1, wherein the primary detent is configured for movement between an engaged position and disengaged position and the secondary detent is configured for movement between an engaged position and disengaged position, wherein when the primary detent is in the engaged position and the secondary detent is in the engaged position, the forkbolt is prevented from moving from the primary position.

3. The latching system as in claim 2, further comprising:
a primary detent spring for biasing the primary detent into the engaged position; and
a secondary detent spring for biasing the secondary detent into the engaged position.

4. The latching system as in claim 3, further comprising:
a backing plate, the forkbolt pivot, the primary detent pivot and the secondary detent pivot each being fixedly secured to the backing plate.

5. The latching system as in claim 4, wherein when the primary detent is in the disengaged position, the primary detent does not prevent movement of the forkbolt from the primary position.

6. The latching system as in claim 5, wherein when the secondary detent is in the engaged position it will contact the primary detent and prevent the primary detent from moving from engaged position towards the disengaged position.

7. The latching system as in claim 2, wherein when the primary detent is in the disengaged position, the primary detent does not prevent movement of the forkbolt from the primary position.

8. The latching system as in claim 7, wherein when the secondary detent is in the engaged position it will contact the primary detent and prevent the primary detent from moving from engaged position towards the disengaged position.

9. The latching system as in claim 2, wherein when the secondary detent is in the engaged position it will contact the primary detent and prevent the primary detent from moving from engaged position towards the disengaged position.

10. A vehicle latch, comprising:
a latching system for a vehicle latch, comprising:
a forkbolt for retaining a striker in a first striker position and a second striker position, the forkbolt configured for movement about a forkbolt pivot between at least a primary position and secondary position, the primary position corresponding to the first striker position and the secondary position corresponding to the second striker position;
a primary detent configured for movement about a primary detent pivot, the primary detent having an elongated opening for rotatably receiving the primary detent pivot, the elongated opening being larger than the primary detent pivot; and
a secondary detent configured for movement about a secondary detent pivot, wherein the primary detent has a bite for contact with the secondary detent and a radius of the bite of the primary detent is centered with a center of the elongated opening such that as the forkbolt moves from the second striker position to the first striker position the primary detent translates or moves with respect to the primary detent pivot and the primary detent also rotates about the primary detent pivot.

11. The vehicle latch as in claim 10, wherein the primary detent is configured for movement between an engaged position and disengaged position and the secondary detent is configured for movement between an engaged position and disengaged position, wherein when the primary detent is in the engaged position and the secondary detent is in the engaged position, the forkbolt is prevented from moving from the primary position.

12. The vehicle latch as in claim 11, further comprising:
a primary detent spring for biasing the primary detent into the engaged position; and
a secondary detent spring for biasing the secondary detent into the engaged position.

13. The vehicle latch as in claim 12, further comprising:
a backing plate, the forkbolt pivot, the primary detent pivot and the secondary detent pivot each being fixedly secured to the backing plate.

14. The vehicle latch as in claim 13, wherein when the primary detent is in the disengaged position, the primary detent does not prevent movement of the forkbolt from the primary position.

15. The vehicle latch as in claim 14, wherein when the secondary detent is in the engaged position it will contact the primary detent and prevent the primary detent from moving from engaged position towards the disengaged position.

16. The vehicle latch as in claim 11, wherein when the primary detent is in the disengaged position, the primary detent does not prevent movement of the forkbolt from the primary position.

17. The vehicle latch as in claim 16, wherein when the secondary detent is in the engaged position it will contact the primary detent and prevent the primary detent from moving from engaged position towards the disengaged position.

18. The vehicle latch as in claim 11, wherein when the secondary detent is in the engaged position it will contact the primary detent and prevent the primary detent from moving from engaged position towards the disengaged position.

19. A method for retaining and releasing a striker of a latching system for a vehicle latch, comprising:
retaining a striker in a first striker position and a second striker position with a forkbolt, the forkbolt configured for movement about a forkbolt pivot between at least a primary position and secondary position, the primary position corresponding to the first striker position and the secondary position corresponding to the second striker position;
retaining the forkbolt in the primary position with a primary detent configured for movement about a primary detent pivot, the primary detent having an elongated opening for rotatably receiving the primary detent pivot, the elongated opening being larger than the primary detent pivot, the primary detent retaining the forkbolt in the primary position when the primary detent is in an engaged position; and
retaining the primary detent in the engaged position with a secondary detent configured for movement about a secondary detent pivot, wherein the primary detent has a bite for contact with the secondary detent and a radius of the bite of the primary detent is centered with a center of the elongated opening such that as the forkbolt moves from the second striker position to the first striker position the primary detent translates or moves with respect to the primary detent pivot and the primary detent also rotates about the primary detent pivot, wherein the primary detent is configured for movement between the engaged position and disengaged position and the secondary detent is configured for movement between an engaged position and disengaged position, wherein when the primary detent is in the engaged position and the secondary detent is in the engaged position, the forkbolt is prevented from moving from the primary position.

20. The method as in claim 19, further comprising:
biasing the primary detent into the engaged position with a primary detent spring; and
biasing the secondary detent into the engaged position with a secondary detent spring.
